(19) United States
(12) Patent Application Publication
(10) Pub. No.: US 2026/0134288 A1
(43) Pub. Date: May 14, 2026

(54) VIRTUAL BEHAVIORAL TRAINING SIMULATION SYSTEM AND TRAINING THEREOF

(71) Applicant: Father Flanagan's Boys' Home Doing Business as Boys Town National Research Hospital, Omaha, NE (US)

(72) Inventors: Maurice Bailey, Omaha, NE (US); David Burget, Omaha, NE (US); Christa Newman, Omaha, NE (US); Heather Styles-Turbyfill, Omaha, NE (US)

(21) Appl. No.: 19/388,283

(22) Filed: Nov. 13, 2025

Related U.S. Application Data
(60) Provisional application No. 63/719,897, filed on Nov. 13, 2024.

(51) Int. Cl. G06N 3/0895

(52) U.S. Cl. CPC G06N 3/0895

(57) ABSTRACT

A training simulation system and/or method is applied via a virtual environment. The simulation is an application that allows trainees to engage in highly dynamic, unpredictable, and immersive scenarios, which would not be feasible or cost-effective with traditional training methods. Due to the AI-driven nature of the characters, each interaction is unique, offering diverse and individualized experiences for each trainee. The simulation can be trained via a machine learning network based upon both real-world and virtual scenarios, including actions and reactions of counselors and those under care.

### CROSS REFERENCE TO RELATED APPLICATIONS

This application claims priority under 35 U.S.C. § 119(e) to provisional patent application U.S. Serial No. 63/719,897, filed November 13, 2024. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to systems and methods for virtual training. More particularly, but not exclusively, the disclosure includes training via virtual environments that includes augmented human actions and reactions based upon a user’s actions to train and test training techniques that could be used with humans in the real world and provides feedback and evaluation for handling different scenarios and personality types.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

Training for behavioral science, research, healthcare, emergency response, and the like is difficult to simulate. The best training is often live, in-person, and on-the-job, where the trainee is dealing with real people who react differently based upon different actions of the trainee. This can be mentally exhausting, and is not to be taken lightly, as there are real life consequences.

For example, youth care and family services require specialized training to be able to understand the actions of individuals and how to best react to these actions. Identifying behaviors and how a person or people may react is something that can have great benefits, but often requires iterative trainings to best get a feel for how to try to help a person and/or family. This is not something that is afforded, however, as the training often occurs in real time based upon the needs of a young person and/or their family.

The same can be said for healthcare and emergency response situations. These situations are frequently unique and there can be little to no time to prepare or be aware of such a situation. Therefore, while simulated training for these situations occurs, it is often based upon specific events and is something that is either watched or studied, such as via case studies. These situations can provide some insight into how to handle different people and situations for future events, but knowing that people are different and each situation is unique will require the ability to adapt and react differently. However, a lack of experience in such situations can put someone in a spot where they may not be ready or adept at handling the situation. This can elevate the situation and may create additional issues.

Thus, there exists a need in the art for systems and methods to be able to virtually train people in highly dynamic, unpredictable, and immersive scenarios, which heretofore have only been available in real-world scenarios where the stakes are high.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide virtual training via simulations. For example, the training simulations can be developed personal computers, extended reality (XR) headsets, glasses, eyewear, and/or extended reality training rooms.

It is still yet a further object, feature, and/or advantage of the present disclosure to utilize artificial intelligence (AI), large language models (LLMs), Text-to-Speech (TTS), Speech-to-Text (STT), computer vision, object detection, emotion recognition, and teaching models to train the simulation via machine learning and to use the training to continue to improve the simulation.

It is yet another object, feature, and/or advantage of the disclosure to create a virtual environment within a physical space to incorporate AI characters who will respond to a user’s movements, emotion recognition, voice and text, and other surroundings to react as a person may in the real world. Within this immersive setting, trainees can engage with the characters in a natural, headset-free manner, just as they would with real individuals.

It is still a further object, feature, and/or advantage of the disclosure to simulate a wide range of scenarios, making it invaluable for training in behavioral science, research, healthcare, emergency response, education, etc. Its virtual environment and technology enable the creation of dynamic situations that may be impractical or impossible to replicate in real-life settings.

The systems and/or methods disclosed herein can be used in a wide variety of applications. For example, application can be utilized on personal computers, Extended Reality glasses, headsets, or eyewear and within Extended Reality rooms outfitted with technology such as cameras, sensors, projection mapping, and LED screens.

It is preferred the apparatus be safe, cost effective, and durable.

According to some aspects of the present disclosure, a system comprises an AI character comprising at least one psychological traits selective from one or more of a plurality of a psychological diagnoses, background, trauma, neurotypical characteristic, and/or divergent characteristic; at least one user input to communicate with the AI character; and a training model associated with the AI character and the at least one user input, the training model trained to identify classifiers associated with the at least one user input, wherein the classifiers comprise an acceptable input from the at least one user input to satisfy the AI character.

According to at least some aspects of the disclosure, the at least one user input comprises a keyboard; a microphone; and/or computer vision comprising a camera, sensor, and/or Lidar.

According to at least some aspects of the disclosure, the system further comprises a text-to-speech model.

According to at least some aspects of the disclosure, the system further comprises a speech-to-text model.

According to at least some aspects of the disclosure, the AI character comprises a large language model, the large language model configured to prompt the AI character to respond to one or more user inputs based on the at least one psychological traits of the AI character.

According to at least some aspects of the disclosure, the system further comprises an output generator to output a summary of an interaction between a user and the AI character.

According to at least some aspects of the disclosure, the output generator outputs a transcript of the at least one user input and one or more responses from the AI character.

According to at least some aspects of the disclosure, the system further comprises a processor in communication with the AI character and the user input and storing the training model.

According to at least some aspects of the disclosure, the system further comprises an emotional recognition model that is capable of recognizing an emotion of a user and to communicate the emotion to the AI character.

According to some additional aspects of the present disclosure, a virtual training simulation system comprises at least one processor, the at least one processor configured to: present an AI character to a user, the AI character displaying at least one psychological traits selective from one or more of a plurality of a psychological diagnoses, background, trauma, neurotypical characteristic, and/or divergent characteristic; receive a user input from a user via at least one user input, the input in response to a prompt from the AI character and based on a programmed scenario; compare the received user input via a training model, wherein the training model is trained with inputs that includes a plurality of reactions based upon a plurality of inputs to identify reactions to the plurality of inputs; and output a response from the AI character that has been selected by the training model based upon the received user input.

According to at least some aspects of the disclosure, the at least one user input comprises a keyboard; a microphone; and/or computer vision comprising a camera, sensor, and/or Lidar.

According to at least some aspects of the disclosure, the system further comprises receiving emotional recognition data from the user via the computer vision and using the emotional recognition data in the training model to determine the output response from the AI character.

According to at least some aspects of the disclosure, the at least one processor further configured to convert a text response from the AI character to synthetic speech.

According to at least some aspects of the disclosure, the at least one processor further configured to convert a speech file from the at least one user input to a text file for the AI character.

According to at least some aspects of the disclosure, the at least one processor further configured to output a transcript of user inputs and AI character responses for evaluation.

According to at least some aspects of the disclosure, the AI character is a machine-learned model that has been trained using traits and characteristics of real people in order to provide responses similar to real people.

According to still additional aspects of the present disclosure, a virtual training method comprises receiving at least one action in the form of a movement and/or a message from an AI character in a virtual environment; based upon the received action, inputting a response from a human user via one or more user inputs; comparing the inputted response via a training model that has been trained to review training steps for addressing behavior events and instructing the AI character to react based upon the compared response; and evaluating the inputted response to train the human user to handle different actions.

According to at least some aspects of the disclosure, the input response comprises a keyboard input, a spoken input, and/or an emotional recognition input.

According to at least some aspects of the disclosure, the AI character comprises a large language model to respond, in real time, to the inputted response.

According to at least some aspects of the disclosure, the step of evaluating the inputting response comprises the creation of a transcript between the user and the AI character.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a schematic of a virtual training simulation system according to at least some aspects of the present disclosure.

FIG. 2 is a schematic of a virtual training simulation system according to additional aspects of the present disclosure.

FIG. 3 is a schematic of an evaluation system related to virtual training according to at least some aspects of the present disclosure.

FIG. 4 is a flow diagram illustrating some aspects of a virtual training simulation system according to the present disclosure.

FIG. 5 is a flow diagram illustrating some aspects of an evaluation system for use with a virtual training simulation system according to aspects of the present disclosure.

FIG. 6 is another diagram showing aspects of a virtual training simulation system according to the present disclosure.

FIG. 7 is a diagram showing at least some components of a virtual training simulation system according to the present disclosure.

FIG. 8 is a diagram showing aspects and inputs of an example AI character for use with a virtual training simulation system according to the present disclosure.

FIG. 9 is a schematic of an embodiment of the architecture behind the system of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

As will be understood, systems and/or methods of the present disclosure include training simulations that may be utilized via devices, such as computers, handhelds, tablets, smart devices, extended reality (XR) systems, including headsets, glasses, eyewear, XR training rooms, as well as combinations thereof. The system(s) can be part of an app on one or more devices that can be used as part of training for users, such as specific training or operating procedures for an organization or for more general training for dealing with people having different personality traits and/or background profiles. The system can be a highly dynamic environment that utilizes AI-driven characters for interactive role-playing scenarios and feedback.

The XR systems could be in the form of devices that provide both real-time and post-scenario feedback for real-life applications. This would increase the reality of the aspects of the systems provided.

For example, many institutions, including schools, youth/adult health care facilities, prisons, crisis centers, homes, medical facilities, or generally any location could be imitated and/or simulated to train for the different environments. Furthermore, the system(s) can be used as part of a teaching curriculum, training for particular institutions/jobs, as continuing educational opportunities, or as part of a test to determine and perfect updates to standard operating procedures (SOPs) that are generally used to attempt to address and de-escalate threatening or potentially threatening situations, including those that could result in physical or mental harm to people. As these types of situations are generally stressful and time-sensitive, there is heightened benefits to have people that have been trained using simulated situations and involving AI characters having different personality traits and/or backgrounds to best prepare for the encountered situations.

Thus, the systems and methods disclosed herein allow users to be trained to engage in highly dynamic, unpredictable, and immersive scenarios, which would not be feasible or cost-effective with traditional training methods. Due to the AI-driven nature of the AI characters, each interaction of the disclosed systems is unique, offering diverse and individualized experiences for each user.

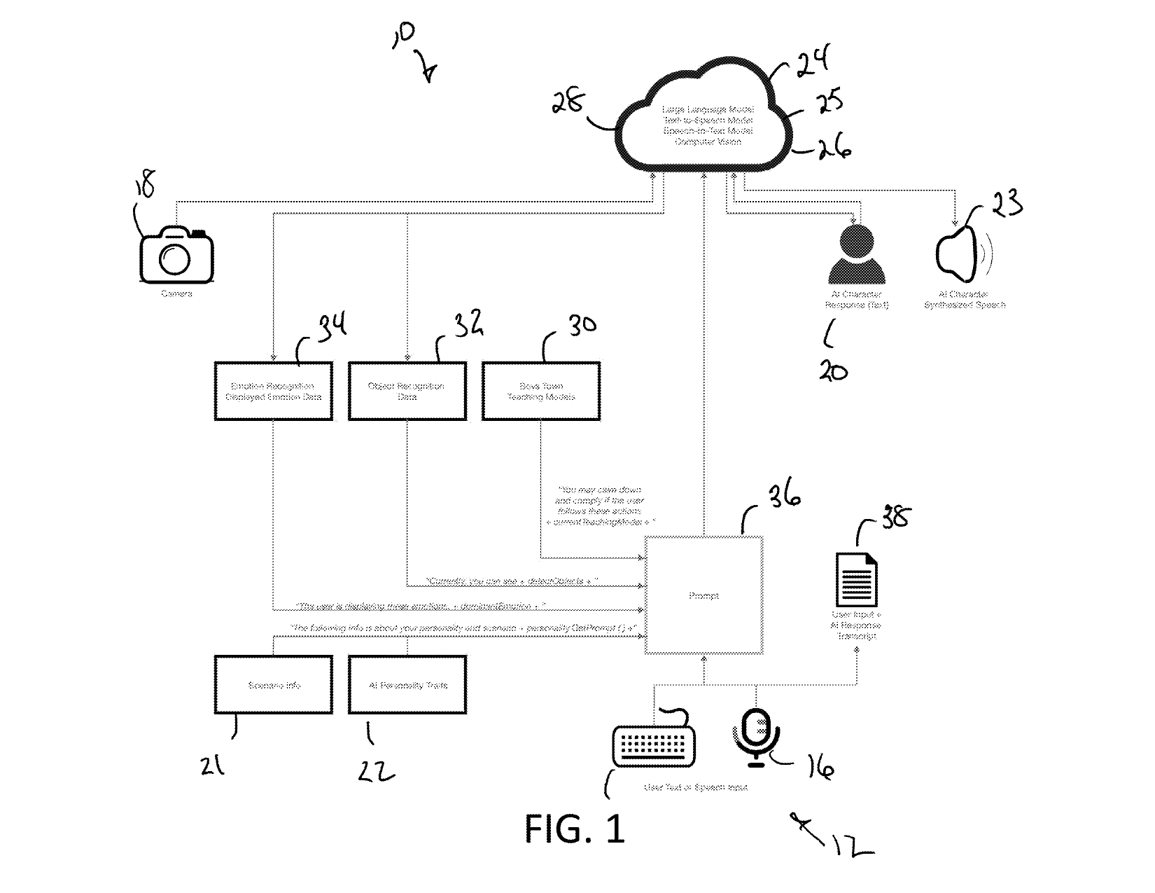

Referring now to FIG. 1, a system 10 is disclosed. The system 10 is a simulated virtual training system that will provide the training referenced. As will be understood, the system 10 includes one or more components that can be operated as an application, such as via a local processor or server, or even using a cloud computing environment. For example, according to at least some embodiments, the system 10 utilizes a game engine (such as a video game engine processor) and various 3D applications. The system 10 utilizes artificial intelligent (AI) features including, but not limited to, large language models (LLMs), text-to-speech (TTS), speech-to-text (STT), object detection, and/or emotion detection, which enable aspects of the system to be able to react and respond to user inputs, such as by responding dynamically to external environmental cues in real time. As will be understood, one or more of these features can be part of an AI character, which provides actions and reactions to a human user input, which would simulate a real world interaction.

Therefore, as shown in FIG. 1, the system 10 includes one or more user inputs 12. These can comprise any human-machine interface, including keyboards 14, microphones 16, mice (not shown), displays, such as graphical user interfaces (GUIs), cameras, Virtual reality glasses, extended reality equipment, etc. The types of inputs 12 are not to be limiting on the present disclosure. According to some embodiments, the user provides an input via one or more of the inputs 12 in response to a query or action from an AI character 20, such as based upon a generated scenario. In other embodiments, the user may start the interaction with an AI character via one or more of the inputs 12, which will start a scenario.

Furthermore, it should be appreciated that the system can support a single human user or multiple human users at the same time. Each of the users can have their own user inputs or grouping of user inputs to be able to interact with the aspects of the system. The supporting of multiple users will aid in training peer relations for different scenarios. Therefore, it should be noted that when user or human user is used in the present disclosure, this should be understood to cover single users or a combination of multiple users interacting with the components of the system.

As noted, part of the system involves an AI character 20. The AI character 20 is selected and programmed to interact with the user of the system. The AI character 20 can be shown as a virtual avatar or can be in the form of a chatbot that provides responses to inputs from the human user.

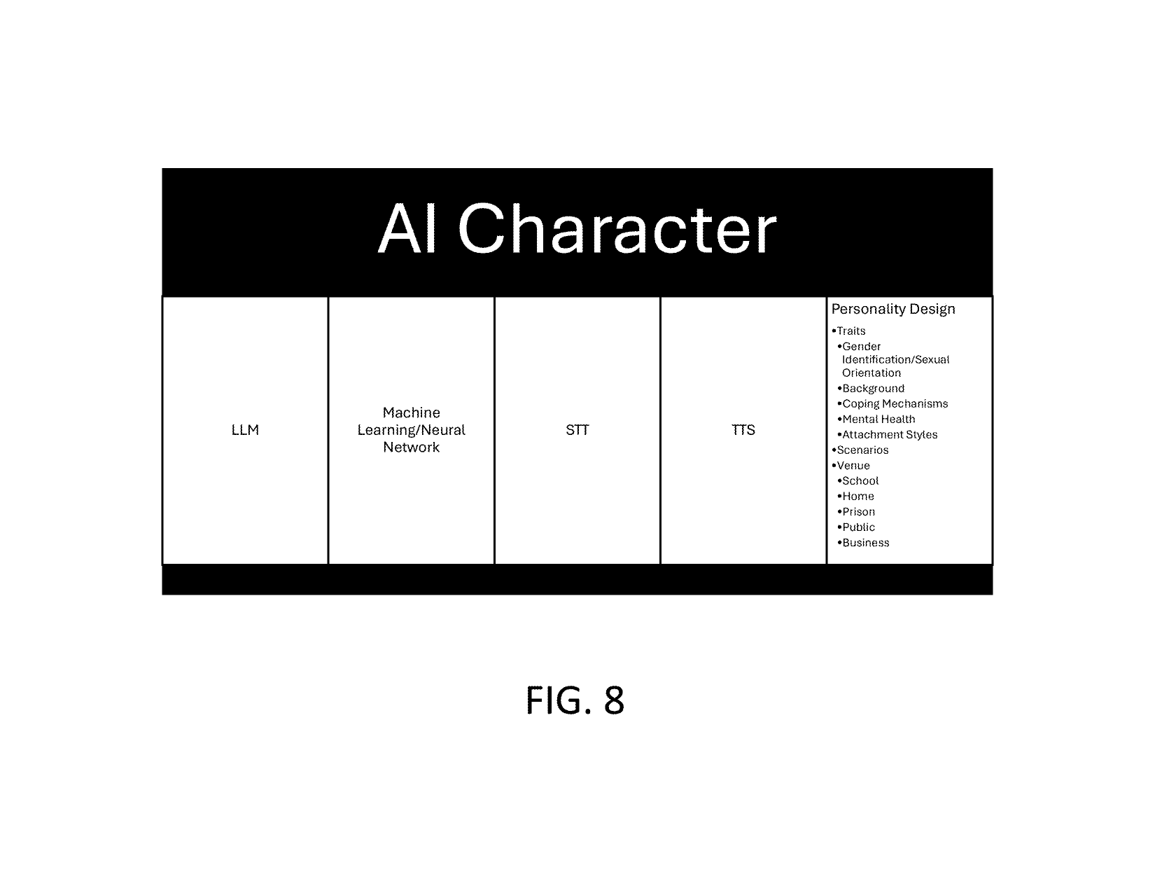

FIG. 8 shows an example of an AI character 20, including some aspects thereof. For example, the AI character can be trained on LLMs and other machine learning/AI models to act and react to user inputs based upon character traits for a particular character. For example, there can be a near-infinite amount of personality traits, demographical information, backgrounds, coping mechanisms, mental health traits, attachment styles, and other inputs that can be chosen (either selected or at random) for each scenario of the system that would affect how the system responds to user inputs.

For example, the traits can be reflective of a testing environment for a particular scenario. If the scenario is a school district, the traits will be reflective of those found in the student population. If the scenario is a prison, the traits will be reflective of those found in the prison population. If the scenario is more generalized, the AI/ML/LLM models can be trained using traits found in the general population. Thus, any and all types and combinations of personality and demographic traits can be selected, such as based upon a scenario.

Accordingly, the following is a list of at least some of the traits/inputs that can be used by the models to generate an AI character, and which will be selected to reflect a population associated with a given scenario.

Gender identity and/or sexual orientation preferences.

Character background information. This can include, but is not limited to, parental status (e.g., history of a broken home), foster care history, refugee status, class status (e.g., poverty, middle class, etc.), history of bullying, substance abuse history, emotional abuse, legal issues, neglect, and generally any other background information that has been shown to affect a person’s personality.

Coping mechanisms. This can include, but is not limited to, artistic expression, withdrawal, aggression, substance abuse, overachieving, self-harm, reckless behavior, and generally any other known coping mechanism.

Mental health history (which can be given on a sliding scale). Examples of inputs can include, but should not be limited to, ADHD, autism spectrum disorder, anxiety disorder, depression, PTSD, bipolar disorder, OCD, low self-esteem, oppositional defiant disorder, addictive tendencies, as well as generally any other known mental health conditions.

Attachment styles. Examples of inputs to the system can include, but should not be limited to, secure, avoidant, anxious, disorganized, etc.

Behavioral cues. In addition to the AI characters psychological/background characteristics, the system includes simulating specific behavioral cues like body language and tone of voice of the AI character. The human user will need to be able to recognize and respond to such cues effectively, which may be based, in part, on some of the inputted information.

Other personality traits. Cultural context can be utilized by the AI character as well. Cultural context refers to the shared beliefs, values, and customs of a group of people within a specific time period. It can also refer to how a person's cultural background impacts their decisions and way of life. The cultural context can be based upon the AI characters personality background and will aid in training on what is culturally appropriate per the different cultural influences.

Examples of these and other traits are used as inputs for the machine learning/AI/LLM models of the AI character 20. As will be understood, these personality traits, along with different scenarios, will provide the background for how the AI character 20 will react/respond to the inputs of the human user. For example, the personality design of the AI character 20 will include a variety of psychological traits to facilitate realistic interactions with individuals having various psychological diagnoses, backgrounds, traumas, as well as individuals with neurotypical or divergent characteristics. This ensures that the human users of the system 10 can engage in empathetic and effective interactions with a diverse range of personality and psychological archetypes. This will provide real-world-based training for the human user, so that they will be able to utilize such training in real-world scenarios.

In addition, the modeling of the AI character 20 allows for evolving or otherwise changing of personality traits, based on the interaction with the user/trainee. For example, the personalities themselves may not change, but attachment styles of the AI character may change. The AI character model is trained with real world research, which has shown that attachment styles of individuals change based upon different types of interaction and/or feedback. Therefore, the models controlling the AI character will mimic this as part of longer term training using the system. The attachment styles will be determined for both the AI character 20 and the user, which will be based upon traits as well as interactions between the user and the system. However, this can change over time and can be part of the feedback/analysis portion of the system 10.

It should further be noted that the AI character 20 include additional training and/or traits, such as those based upon current or historical people. For example, the AI character 20 could be trained on written documents, audio files, biographical data, stories written by others, or generally any available information that pertains to a person, whether living or deceased. The information can be fed into one or more models, such as an LLM, to train the model to react as the living or decease person would react, such as based upon the input information. Such an AI character 20 that is based upon a real person, could provide valuable feedback and/or training. For example, if an AI character 20 were based upon a deceased person, based on their writings, teachings, speeches, and other information, the user of the system could ask questions and get feedback from the AI character 20 to see how they would have responded if they were still alive. This essentially allows users of the system 10 to interact with living or deceased people in ways that would otherwise be unavailable. This could be for training or to have conversations with the trained character. Another advantage would be to allow ancestors to interact with long-dead relatives to see how they would have reacted to current-world issues.

To train the model of an AI character that is based upon a real world person (either alive or deceased), the information of the person is input to the models. This includes a person’s personal information (i.e., biographical information), personal writings (e.g., journals, private and/or public writings, etc.), any recorded information of the individual (audio and/or video based), quotes, as well as any writings or other information from others that will help determine how the real person would or would have responded to inputs from a user.

Furthermore, as noted, the AI character 20 and system as a whole will incorporate the use of models to aid in the use of the system 10. Examples of some of the models shown in FIG. 1 include:

LLMs: The Large Language Model (LLM) 24 allows for natural language interactions between AI characters and trainees (human users). AI characters receive scenarios through prompts in the programming for each game level (scenario), enabling them to engage in realistic conversations with the trainees. A large language model (LLM) is a type of computational model designed for natural language processing tasks such as language generation. As language models, LLMs acquire these abilities by learning statistical relationships from vast amounts of text during a self-supervised and semi-supervised training process. LLMs generally are AI programs trained on vast amounts of data to understand, generate, and translate text, among other natural language processing tasks.

TTS 25: Text-to-Speech (TTS) is the task of generating natural sounding speech given text input. TTS 25 functionality with the AI character 20 enables human users to communicate with the AI character 20 using spoken language.

STT 26: Speech-to-Text detects words in an audio clip by comparing input to one of many machine learning models. Each model has been trained by analyzing millions of examples—in this case, many, many audio recordings of people speaking. For the systems of the present disclosure, STT technology allows the AI character 20 to vocalize its responses through synthetic speech, enhancing the natural interaction between the AI and the human user(s).

Additional models and components of the system 10 include computer vision 28, which includes technology that gathers information about the human user’s environment and actions, including displayed emotion. The computer vision system 28 may include cameras, including stereo cameras, wide angle lenses, and single lens cameras, as well as sensors including LiDAR systems, proximity sensors, and the like. The vision system 28 may incorporate or otherwise be associated with an object recognition model and/or emotion recognition model. The AI character 20 utilizes information obtained from the vision system 28 to provide context and appropriate responses. Thus, it is envisioned that the AI/ML/LLM of the AI character 20 also be trained on human emotion and movement, which may be reflective of additional information for responding.

Still further, biometric devices may be used as human inputs for the system. Biometric devices monitor a human person’s physical and/or emotional state, which can be utilized by the AI character to be able to adjust the interactions and shape the scenario, which will provide additional training and experience for the human user(s).

As noted, the system, including the models and AI training, will utilize machine learning to continually update and enrich character attributes, which will reflect diverse (generalized) traits and characteristics of the population of each scenario/environment. This aids in facilitating the creation of a real-time, relevant training scenario and equips the AI character 20 with contextual data to provide a tailored AI character 20 for personalized scenario-specific interactions with the human user.

Machine learning (ML) is the study of computer algorithms that can improve automatically through experience and by the use of data. It is seen as a part of artificial intelligence. Machine learning algorithms build a model based on sample data, known as “training data”, in order to make predictions or decisions without being explicitly programmed to do so.

While it is envisioned that generally any type of ML (e.g., supervised learning, unsupervised learning, semi-supervised learning, or reinforcement learning) can be utilized by any of the aspects and/or embodiments of the present disclosure utilize supervised learning. Supervised learning (SL) is the machine learning task of learning a function that maps an input to an output based on example input-output pairs. It infers a function from labeled training data consisting of a set of training examples. In supervised learning, each example is a pair consisting of an input object (typically a vector) and a desired output value (also called the supervisory signal). A supervised learning algorithm analyzes the training data and produces an inferred function, which can be used for mapping new examples. An optimal scenario will allow the algorithm to correctly determine the class labels for unseen instances. This requires the learning algorithm to generalize from the training data to unseen situations in a “reasonable” way (see inductive bias). This statistical quality of an algorithm is measured through the so-called generalization error.

To solve a given problem of supervised learning, one has to perform the following steps: (1) Determine the type of training examples. Before doing anything else, the user should decide what kind of data is to be used as a training set. (2) Gather a training set. The training set needs to be representative of the real-world use of the function. Thus, a set of input objects is gathered, and corresponding outputs are also gathered, either from human experts or from measurements. (3) Determine the input feature representation of the learned function. The accuracy of the learned function depends strongly on how the input object is represented. Typically, the input object is transformed into a feature vector, which contains a number of features that are descriptive of the object. The number of features should not be too large, because of the curse of dimensionality; but should contain enough information to accurately predict the output. (4) Determine the structure of the learned function and corresponding learning algorithm. For example, the engineer may choose to use support-vector machines, regression analysis, or decision trees. (5) Complete the design. Run the learning algorithm on the gathered training set. Some supervised learning algorithms require the user to determine certain control parameters. These parameters may be adjusted by optimizing performance on a subset (called a validation set) of the training set, or via cross-validation. (6) Evaluate the accuracy of the learned function. After parameter adjustment and learning, the performance of the resulting function should be measured on a test set that is separate from the training set.

As will be understood, while generally any type of SL can be utilized, the example provided herein utilized three different classification algorithms to train the model, namely the support vector machine (SVM), k-Nearest Neighbors (k-NN), and classification ensemble (ENS).

Support-vector machines (SVMs, also support-vector networks) are supervised learning models with associated learning algorithms that analyze data for classification and regression analysis. Given a set of training examples, each marked as belonging to one of two categories, an SVM training algorithm builds a model that assigns new examples to one category or the other, making it a non-probabilistic binary linear classifier (although methods such as Platt scaling exist to use SVM in a probabilistic classification setting). SVM maps training examples to points in space so as to maximize the width of the gap between the two categories. New examples are then mapped into that same space and predicted to belong to a category based on which side of the gap they fall.

The k-nearest neighbors algorithm (k-NN) is a non-parametric classification method. k-NN is a type of classification where the function is only approximated locally, and all computation is deferred until function evaluation. Since this algorithm relies on distance for classification, if the features represent different physical units or come in vastly different scales then normalizing the training data can improve its accuracy dramatically.

Classification ensemble may also be referred to as ensemble learning. Ensemble methods use multiple learning algorithms to obtain better predictive performance than could be obtained from any of the constituent learning algorithms alone. Unlike a statistical ensemble in statistical mechanics, which is usually infinite, a machine learning ensemble consists of only a concrete finite set of alternative models, but typically allows for much more flexible structure to exist among those alternatives.

The trained model and the associated machine learning and application of the model will utilize processors, modules, memories, databases, networks, and potentially user interfaces to show the results and allow changes to be made.

Still additional aspects and/or components of the system 10 shown in FIG. 1 include a processor/server 36, which directs the information from the inputs, models, and AI character 20. Outputs, such as speakers 23 allow for the TTS to be audible for the human user from the AI character 20, and other outputs, such as transcript outputs 38 can be provided. The transcript output can be on a machine, printed, or otherwise saved as either or both of a text file and audio file that can be reviewed for further training and feedback.

As shown in FIG. 1, the system 10 including the components are either part of a single processor/server, or part of a network wherein the components can be located on different servers/processors and in communication with one another. It should be appreciated that the communications can be wired or wireless. There are numerous arrows in FIG. 1 that shows the flow of information from one or more of the components to the other components, which is indicative of the system operating to provide real-time interaction between the human user and the AI character 20. The machine-learned models will continuously update the interactions between the user and the AI character 20 based upon identified classifiers in the machine learning that indicates how a real person would react to the inputs of the human user, which will provide the real-time simulation that can be used for training.

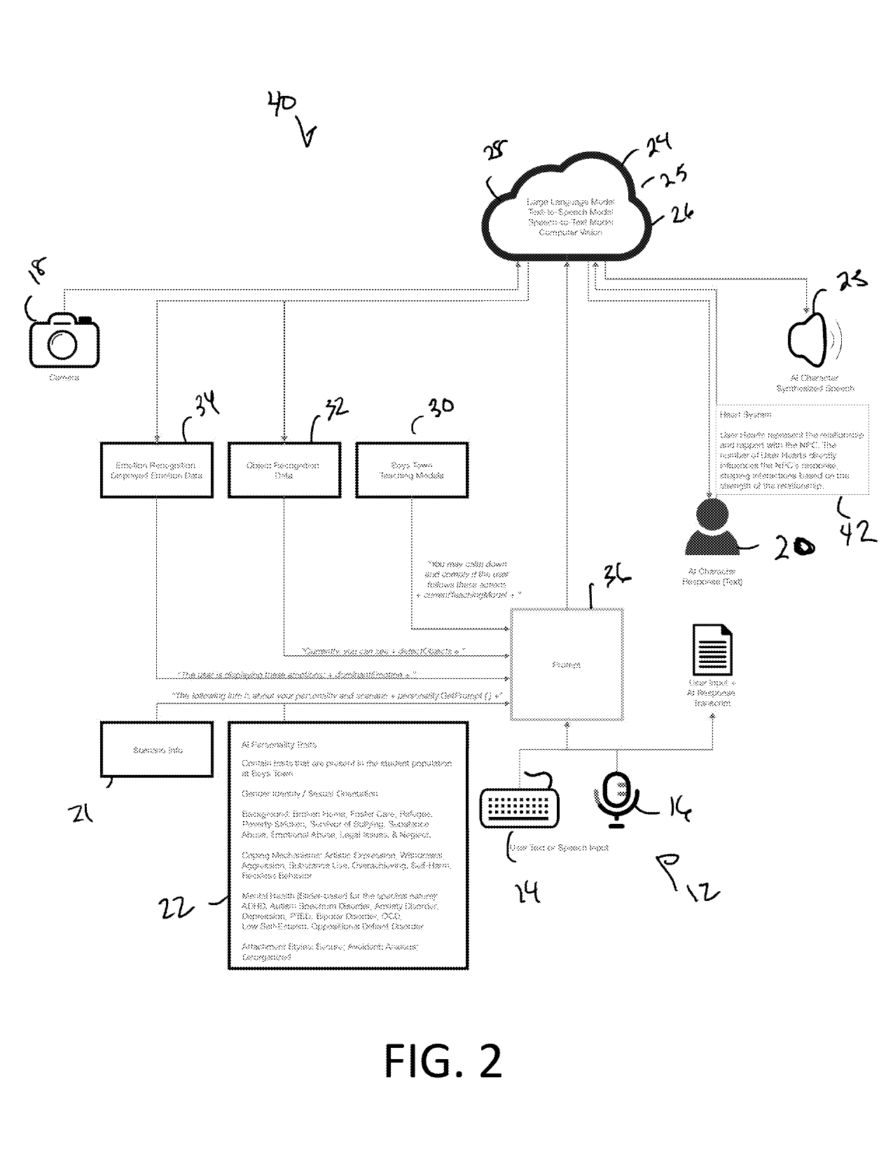

FIG. 2 shows a system 40 similar to that of FIG. 1, but with some additional information and features. For example, a heart system 42 is shown. The heart system 42 shows the inclusion of the relationship between the human user and the AI character 20, such as based upon the scenario information 21. The heart system 42 can include “User Hearts”, which can represent the relationship and rapport with the NPC (AI character). The number of User Hearts directly influences the AI character’s response, shaping interactions based on the strength of the relationship, as well as type of relationship.

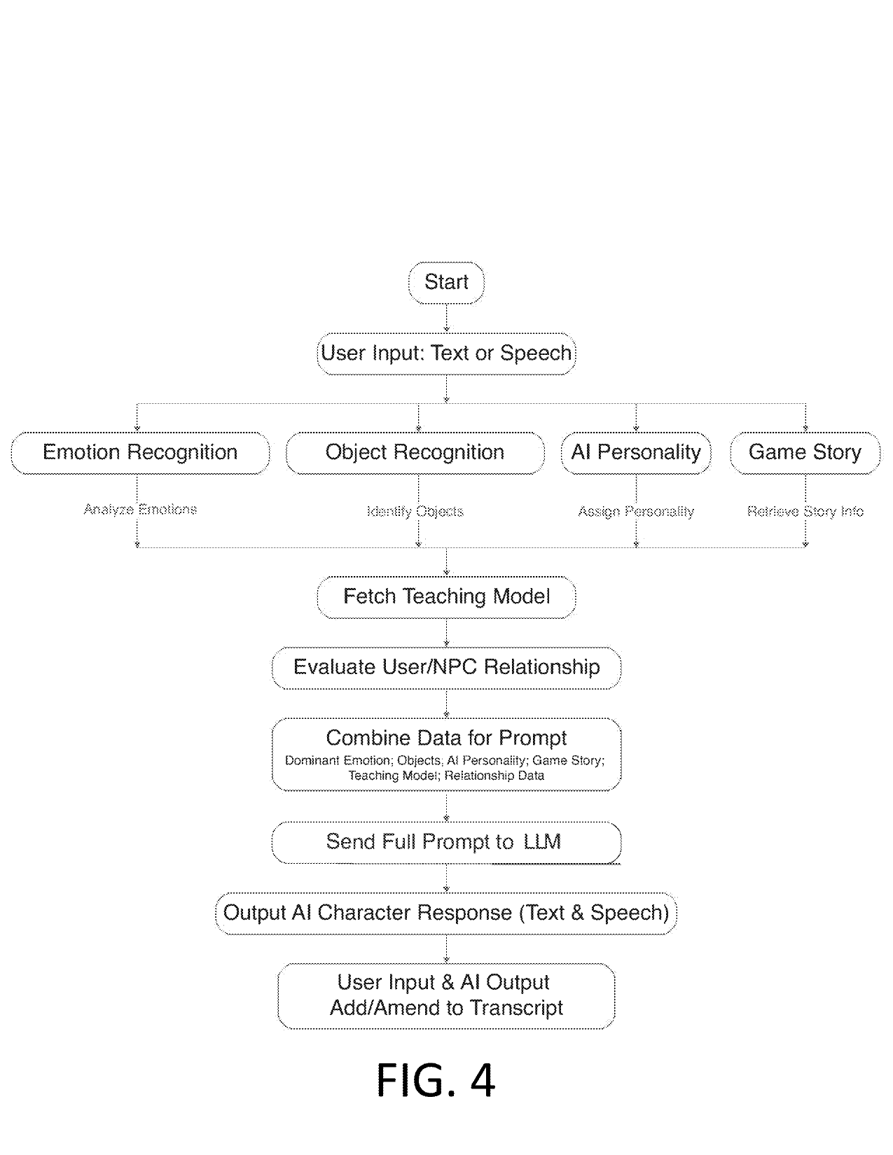

Moving now to application of the systems 10, 40 of FIGS. 1 and 2, FIG. 4 is a flow diagram showing an example of an operation of the system 10, such as for training a human user. As shown, the system is started, which can be by the user as indicated in the step “User Input: Text or Speech”. The human user can provide such an input via one or more of the user inputs 12.

The next step includes how the AI character 20 will utilize information specific to a scenario and other information. For example, one of the components of the step is listed as “Game Story”. The “Game Story” refers to a scenario, which includes, but is not limited to, the environment the training will take place, as well as the starting mood, condition, mental state, and other conditions currently affecting the AI character 20. Such conditions can be both internal and external, and dependent on issues, moods, etc. As noted, the “Game Story” effectively retrieves and loads story information related to such conditions. The step also includes the “AI Personality”, which is the assigned AI personality traits that have been disclosed herein and shown in the figures.

Additional factors at this step include “Object Recognition” by the AI character 20, which includes use of the vision system 28 to identify objects and environmental conditions of the human user. This may include the use of cameras, sensors, LiDAR, and the like. “Emotion Recognition” is also included at this step, wherein the vision system 28 is used to detect any emotional queues from the human user, which can be communicated to the machine learned AI character to identify any classifiers that would associate such a detection with a perceived emotion, which could alter the “thinking” and response by the AI character 20.

All of this information is combined and analyzed by the processor and machine learning algorithm as one part of inputs to form a reaction/response by the AI character. The “Fetch Teaching Model” step is next. Teaching Models provide guidance to the LLMs, enabling the AI to detect when the trainee is following specific steps and comply/de-escalate in their interactions. Additionally, the users' responses are evaluated and graded against the teaching models after the role-play is complete, allowing for personalized feedback and learning.

The Teaching Model will be fed to the ML algorithm for identification of one or more classifiers that should be found for the scenario, such as based upon inputted training modules, manuals, standard operating procedures, etc. The system will look for such classifiers in the form of the inputs from the human user. Such classifiers can include escalators, de-escalators, status quo classifiers, or other classifiers that may affect how the AI character 20 responds to the human user input(s).

Next, at the “Evaluate User/NPC Relationship” step, the system will determine what relationship the AI character 20 and the human user may have, such as based upon the scenario/game story selected. For example, this could be counselor-student, teacher-student, doctor-patient, officer-inmate, officer-potential criminal, parent-child, family-family, or any other potential relationship based upon the training scenario.

At the “Combine Data for Prompt” step, the recognized emotion (e.g., the dominant emotion detected), objects, AI personality, game story/scenario, teaching model, and relationship data are all combined and evaluated via the AI/LLM in order to prepare a response from the AI character.

At the “Send Full Prompt to LLM” step, the data has been compiled and the models have determined how to respond to the human user input.

At the “Output AI Character Response (Text & Speech)” step, the chosen response is provided to the human user. This can be in the form of a text file (such as via chatbot) or can be synthetic text played via a speaker.

It should be noted that the steps can be continued for any amount of time, which can be set by the scenario/game story. In addition, thresholds can be set that would indicate a need to end the scenario to provide immediate feedback to the human user. For example, based upon the human user’s performance (i.e., how the AI character decides to respond), the system dynamically adjusts the scenarios (escalating or de-escalating AI character behaviors).

At the “User Input & AI Output Add/Amend to Transcript” step, such back and forth (regardless of the amount of back and forth) can be saved and outputted to a file for future evaluation and/or review, such as to further the training of the human user.

Furthermore, as will be understood, after each scenario, an AI Evaluator provides real-time feedback. The Feedback is graded against the rubric and quality components (trainee tone and volume, eye contact, body language, etc.), similar to an in-person training model. Based on trainee performance (including quality components), the system dynamically adjusts the scenarios (escalating or de-escalating AI character behaviors). This is a key part of replicating real-world challenges. It would also be part of the rubric system since the escalating or de-escalating behaviors would not only be based on what the trainee says and does but also where they are in the rubric and process steps. Difficulty increases with level progression.

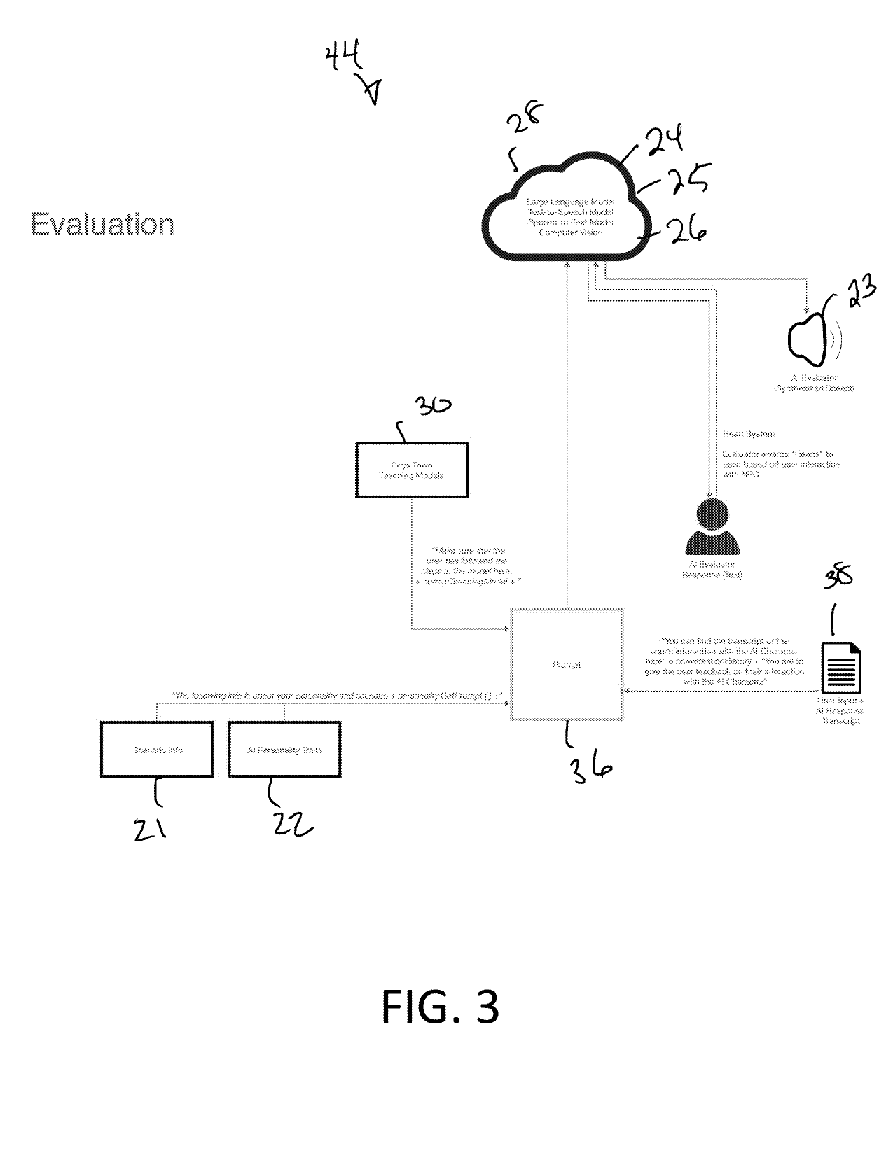

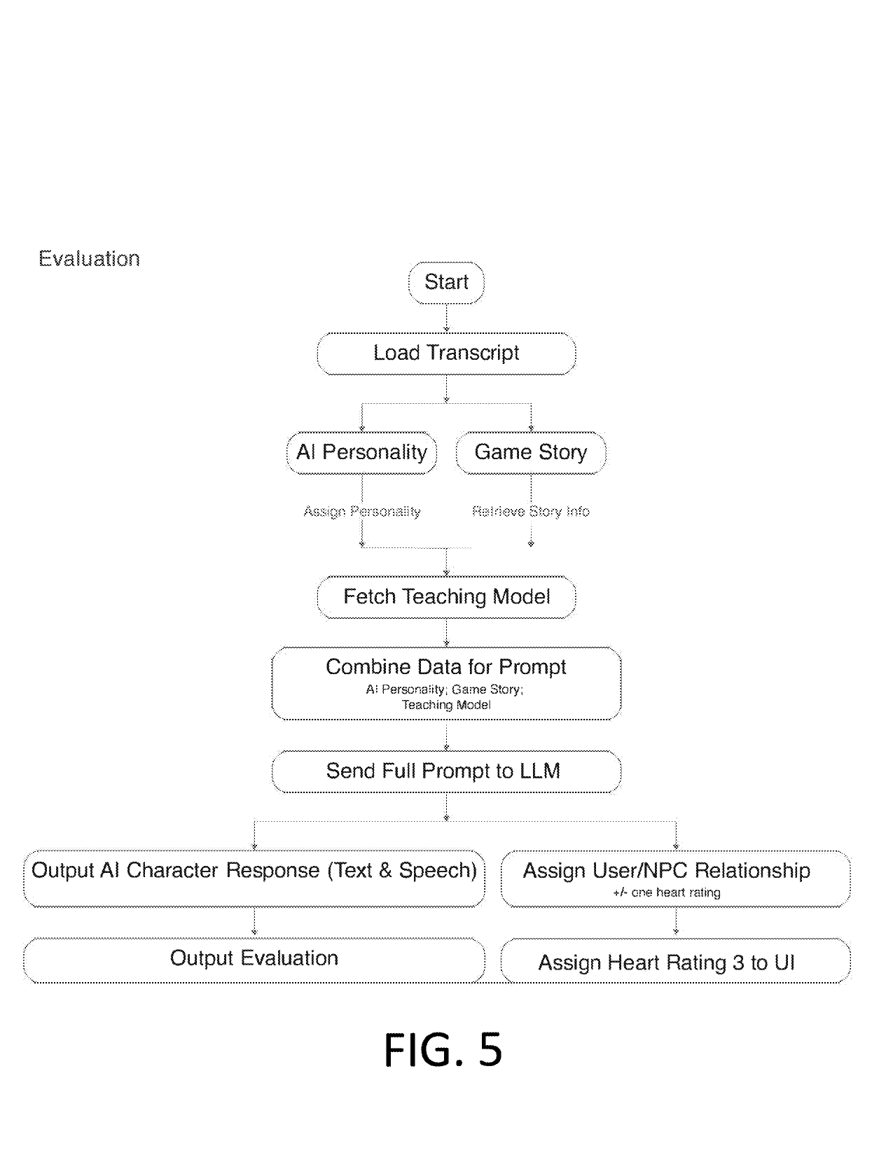

Referring now to FIGS. 3 and 5, aspects will be described relating to an evaluation system 44. As noted, the systems 10 and 40 can be used as part of a training program to help human users train how to handle people and situations, such as those based upon the AI character’s inputs (AI personality traits) and scenario information. While there will be some feedback in the response of the AI character and the transcript, additional aspects of the present disclosure include evaluation of the human user. Such evaluation refers to how the human user handles different personality types and scenarios, such as with respect to known training models/methods that have been input into the system.

One aspect will include real-time evaluation. FIG. 3 shows a teaching model 30. This teaching model is a machine learning model that has been trained using many inputs. For example, such inputs can include standard operating procedures that have been developed over time for different scenarios. These can be teaching models/standard operating procedures (SOPs) for dealing with students having different personality traits and in different scenarios, SOPs for handling prisoners in different situations, SOPs for de-escalating situations regardless of the location, SOPs and training techniques for responding to different situations and scenarios, and generally any manner of handling different personality types, situations, and scenarios that may arise during use of the systems presented. Some of these may be specific to organizations, such as Effective Praise, Proactive Teaching, Corrective Teaching, Corrective Ongoing, and motivation systems. In such scenarios, the evaluation system can be a structured evaluation system based on an organization’s rubrics/behavioral techniques.

The teaching models 30 can provide guidance to the LLMs 24, enabling the AI character 20 to detect when the human user is following specific steps and comply/de-escalate in their interactions. This provides the contemporaneous response and evaluation to the human user. Based on human user performance (including quality components), the system dynamically adjusts the scenarios (escalating or de-escalating AI character behaviors). This is a key part of replicating real-world challenges. It would also be part of the rubric system since the escalating or de-escalating behaviors would not only be based on what the trainee says and does but also where they are in the rubric and process steps. Difficulty increases with level progression.

Additionally, the users' responses are evaluated and graded against the teaching models after the role-play is complete, allowing for personalized feedback and learning. The AI system evaluates trainee engagements to develop personalized training approaches tailored to individual learning requirements and previous achievements.

After each scenario, an AI Evaluator provides real-time feedback. The Feedback is graded against the rubric and quality components (trainee tone and volume, eye contact, body language, etc.), similar to an in-person training model. As noted in FIG. 5, the evaluation system 44 includes the starting point. The transcript that is created during the back and forth of the scenario between the human user and the AI character 20 is loaded. The details of the AI character’s personality traits and the game story scenario are used for the evaluation.

A teaching model that should be applied to the system, based upon the personality traits and scenario is selected by the model, which is based upon the inputted information. The data (AI personality, game story/scenario, and teaching model) is combined via a processor and the LLM is used to provide a prompt.

The prompt can include output AI character responses, such as text or speech to provide information on how the human user fared. This would be an output evaluation indicating positives, negatives, and even recommendations for the human user in similar situations. In addition, the prompt can include assigning a user/non-person character relationship in the form of heart ratings. The heart ratings can indicate the success rate in how the human user responded and acted in response to the AI character and scenario.

Thus, the incorporation of an “Evaluator" AI assesses user performance during role play to ensure accuracy based on the targeted teaching model or SOP and assigns a grade. The transcripts are also available for review by human evaluators to provide additional feedback and ensure precision.

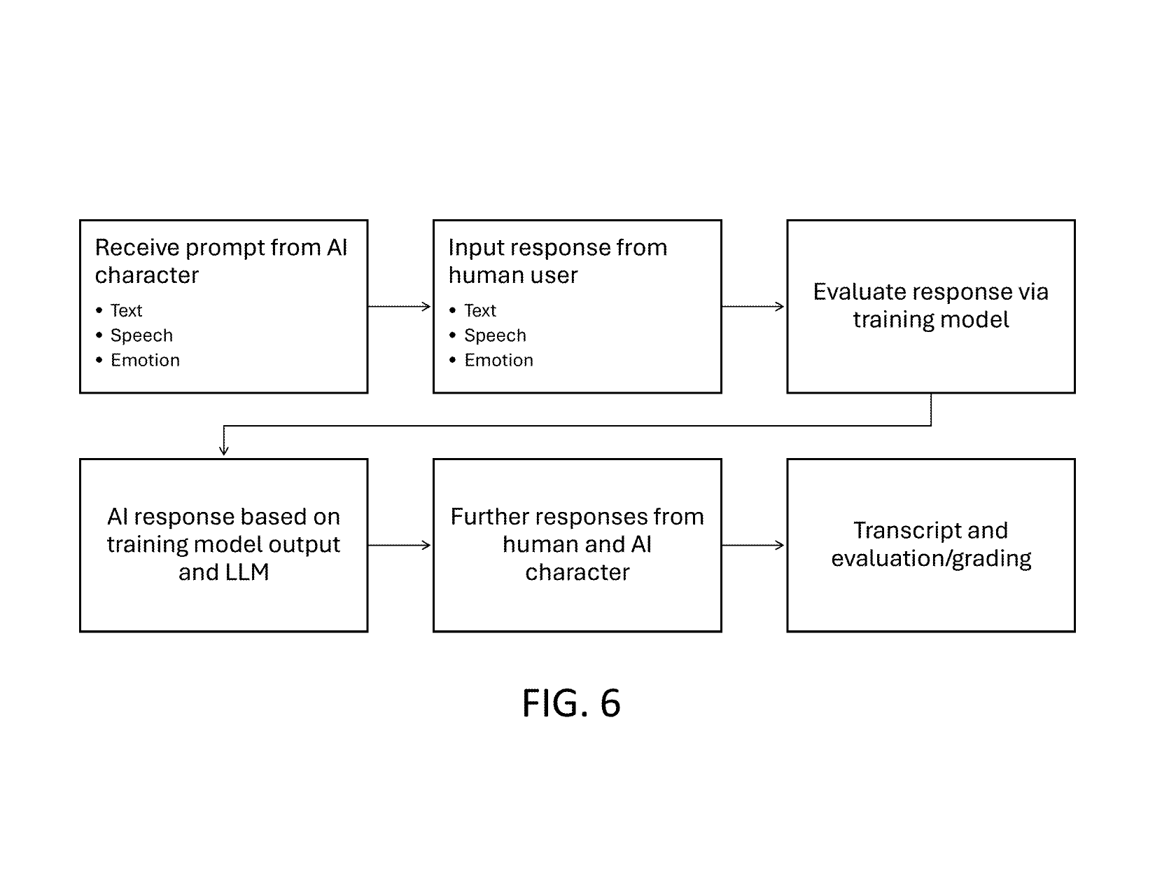

Moving now to FIG. 6, another diagram of operation is shown. The figure includes the start of an engagement with an AI character, such as by receiving a prompt from the AI character in the form of text, speech, and/or emotion. This will be a combination of personality traits and a selected scenario.

The human user is then intended to evaluate the prompt and provide a response via a user input in the form of text, speech, and/or emotional cues, which can be received by the AI character and using models, identifying what the human user is intending to convey. The training model will also compare the human user input based upon inputs to the system, to see if the human response matched any classifiers in the model that would indicate how the AI character could or should respond. The AI character uses this information, along with LLMs and responds to the human user input, at which point the human is able to further respond in an effort to address the situation of the scenario, which may be a de-escalation of a situation. This continues back and forth until the scenario ends. There are different ways a scenario could end. This could be a successful de-escalation or identification and response by the human user, could be an unwanted (i.e., bad) end based upon a missed or undesirable response by the human user, or could be somewhere in-between, but stopped due to a time limit for the scenario. There is an almost limitless amount of ending scenarios that could end the scenario and these could all depend on the back and forth responses.

In any case, after the scenario has ended, the transcript can be evaluated and even graded. Feedback can be given to the human user to better understand what happened and to provide support and further information should a similar situation arise at a later time/date.

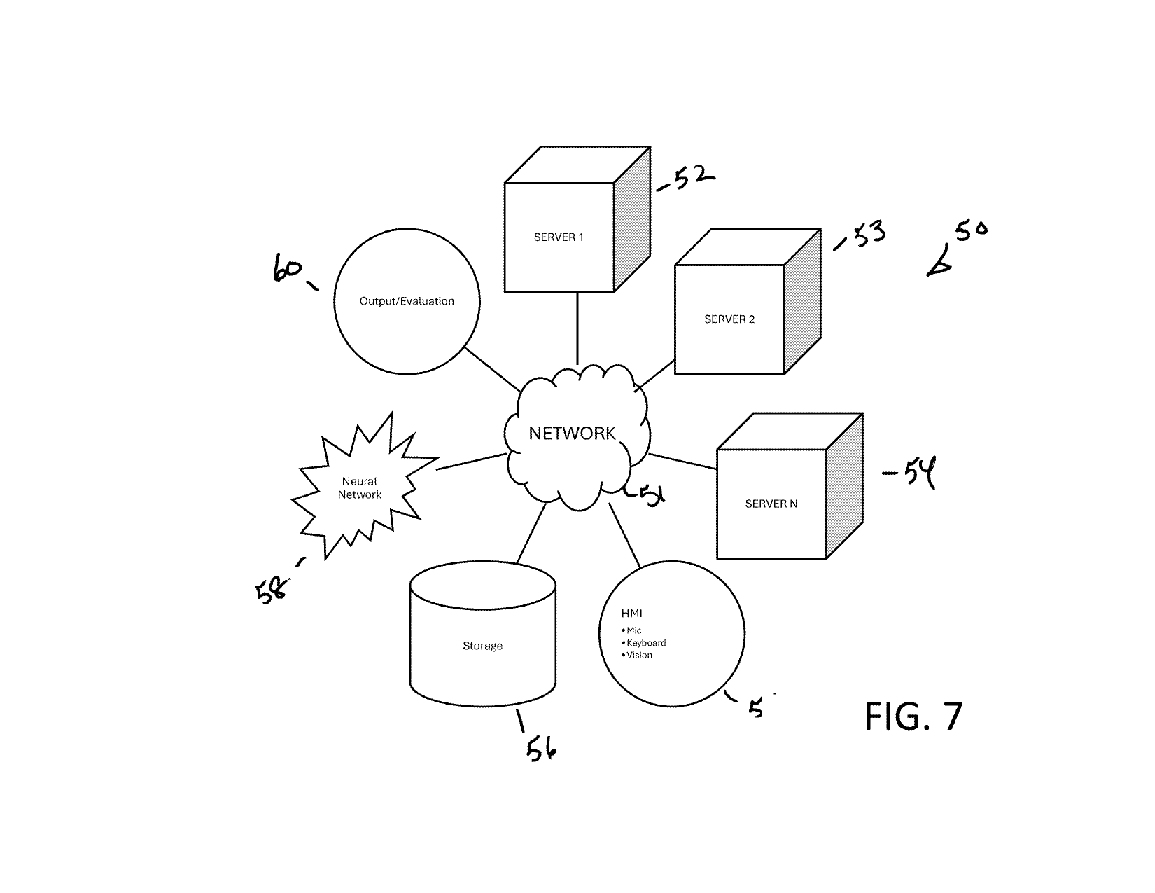

Moving now to FIG. 7, an example network that would include the systems 10, 40, and 44 is shown. It should be appreciated that the components of the figure are shown for example, purposes, and are not intended to be limiting to the disclosure. For example, as has been noted, the systems will operate with both peripheral equipment and virtual environments that are in communication with one another. This can be done wired, such as a closed network, or wirelessly involved both local and remote equipment (e.g., servers, processors, etc.) that can house any of the models, AI, and other portions of the disclosure.

FIG. 7 shows an example system 50, which can be for any of the systems disclosed. The system 50 includes a network 51, through which the portions of the system are in communication with one another. The network 51 may be a wireless network, such as a cloud based network, or may be a wired network. Components of the system 50 include one or more servers, including Server₁52, Server₂53, and Server_{N}54, wherein the N refers to any number greater than two. It should be noted that a single server with processing capacity be used, or any number of servers each housing different components of the system can be utilized.

The system 50 includes a number of human-machine interfaces (HMI) 55, which include the user inputs disclosed. These can include, but are not limited to microphones, keyboards, mice, cameras, sensors, speakers, and other peripherals. A storage system 56 is shown, which can include memory for the system 50. One or more neural networks 58 can be used. The neural networks can be part of the models of the system to continually train and refine the models to best provide the responses from the AI characters, the evaluation, as well as being continually trained based upon real-world inputs that are added to the system to optimize the same. The output/evaluation model 60 is also included.

In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

The Internet Protocol (“IP”) is the principal communications protocol in the Internet protocol suite for relaying datagrams across network boundaries. Its routing function enables internetworking, and essentially establishes the Internet. IP has the task of delivering packets from the source host to the destination host solely based on the IP addresses in the packet headers. For this purpose, IP defines packet structures that encapsulate the data to be delivered. It also defines addressing methods that are used to label the datagram with source and destination information.

The Transmission Control Protocol (“TCP”) is one of the main protocols of the Internet protocol suite. It originated in the initial network implementation in which it complemented the IP. Therefore, the entire suite is commonly referred to as TCP/IP. TCP provides reliable, ordered, and error-checked delivery of a stream of octets (bytes) between applications running on hosts communicating via an IP network. Major internet applications such as the World Wide Web, email, remote administration, and file transfer rely on TCP, which is part of the Transport Layer of the TCP/IP suite.

Transport Layer Security, and its predecessor Secure Sockets Layer (“SSL/TLS”), often runs on top of TCP. SSL/TLS are cryptographic protocols designed to provide communications security over a computer network. Several versions of the protocols find widespread use in applications such as web browsing, email, instant messaging, and voice over IP (VoIP”). Websites can use TLS to secure all communications between their servers and web browsers.

The system includes numerous electrical and/or computer modules, equipment, protocols, and the like. The following is a description of at least some components, protocols, and/or systems, which may be used with the system. However, note that not all are used or required.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

The system will include an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

In the instant case, the memory could include the machine learned classifiers, so as to fit the parameters of the model and to quickly and accurately identify the results based on the trained classifiers.

Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the central processing unit accesses and manipulates data stored in the memory of the non-transitory computer readable medium using the relationships and logic dictated by the software application and generated using the compiler.

In one embodiment, the software application and the compiler are tangibly embodied in the computer-readable medium. When the instructions are read and executed by the non-transitory computer readable medium, the non-transitory computer readable medium performs the steps necessary to implement and/or use the present invention. A software application, operating instructions, and/or firmware (semi-permanent software programmed into read-only memory) may also be tangibly embodied in the memory and/or data communication devices, thereby making the software application a product or article of manufacture according to the present invention.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

It is envisioned that the machine learned models and any of the training of the same could include cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

A cloud computing environment is service oriented with a focus on statelessness, low coupling, modularity, and semantic interoperability. At the heart of cloud computing is an infrastructure comprising a network of interconnected nodes.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

The use of a cloud or cloud computing has been included. There are different types of cloud computing models considered.

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

The power supply outputs a particular voltage to a device or component or components of a device. The power supply could be a direct current (“DC”) power supply (e.g., a battery), an alternating current (“AC”) power supply, a linear regulator, etc. The power supply can be configured with a microcontroller to receive power from other grid-independent power sources, such as a generator or solar panel.

With respect to batteries, a dry cell battery may be used. Additionally, the battery may be rechargeable, such as a lead-acid battery, a low self-discharge nickel metal hydride battery (“LSD-NiMH”) battery, a nickel–cadmium battery (“NiCd”), a lithium-ion battery, or a lithium-ion polymer (“LiPo”) battery. Careful attention should be taken if using a lithium-ion battery or a LiPo battery to avoid the risk of unexpected ignition from the heat generated by the battery. While such incidents are rare, they can be minimized via appropriate design, installation, procedures, and layers of safeguards such that the risk is acceptable.

The power supply could also be driven by a power generating system, such as a dynamo using a commutator or through electromagnetic induction. Electromagnetic induction eliminates the need for batteries or dynamo systems but requires a magnet to be placed on a moving component of the system.

The power supply may also include an emergency stop feature, also known as a “kill switch,” to shut off the machinery in an emergency or any other safety mechanisms known to prevent injury to users of the machine. The emergency stop feature or other safety mechanisms may need user input or may use automatic sensors to detect and determine when to take a specific course of action for safety purposes.

A user interface is how the user interacts with a machine. The user interface can be a digital interface, a command-line interface, a graphical user interface (“GUI”), oral interface, virtual reality interface, or any other way a user can interact with a machine (user-machine interface). For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, speakers, microphones, LIDAR, RADAR, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface can also be configured with a microcontroller to display conditions or data associated with the main device in real-time or substantially real-time.

The sensors sense one or more characteristics of an object and can include, for example, accelerometers, position sensors, pressure sensors (including weight sensors), or fluid level sensors among many others. The accelerometers can sense acceleration of an object in a variety of directions (e.g., an x-direction, a y-direction, etc.). The position sensors can sense the position of one or more components of an object. For example, the position sensors can sense the position of an object relative to another fixed object such as a wall. Pressure sensors can sense the pressure of a gas or a liquid or even the weight of an object. The fluid level sensors can sense a measurement of fluid contained in a container or the depth of a fluid in its natural form such as water in a river or a lake. Fewer or more sensors can be provided as desired. For example, a rotational sensor can be used to detect speed(s) of object(s), a photodetector can be used to detect light or other electromagnetic radiation, a distance sensor can be used to detect the distance an object has traveled, a timer can be used for detecting a length of time an object has been used and/or the length of time any component has been used, and a temperature sensor can be used to detect the temperature of an object or fluid.

Therefore, as will be appreciated, the systems provided herein provide numerous advantages and improvements. The systems can be used to teach different teaching models and SOPs in a highly dynamic environment using AI-driven characters for interactive role-playing scenarios and feedback. The systems allow human users to engage in highly dynamic, unpredictable, and immersive scenarios, which would not be feasible or cost-effective with traditional training methods. Due to the AI-driven nature of the characters, each interaction is unique, offering diverse and individualized experiences for each trainee.

As noted, the use of personal computers, Extended Reality glasses, headsets, or eyewear and within Extended Reality rooms outfitted with technology such as cameras, sensors, projection mapping, and LED screens to create real-world situations will create a gaming-like environment within a physical space. The AI characters, utilizing the camera and microphone technology, can perceive and respond to their surroundings and are presented as lifelike holograms. Within this immersive setting, human users can engage with the characters in a natural, headset-free manner, just as they would with real individuals.

A number of additional features and/or advantages of the system as shown and/or described are included. The following list is non-exhaustive and includes some elements that provide even more advantages and/or improvements over previous systems.

The system utilizes a truth-anchored retrieval-augmented generation (RAG) that includes a “Walled Garden” knowledge governance. This describes a retrieval-augmented generation where the evaluator/agent only grounds responses in a curated, versioned corpus (research, scripts, videos) that has been marked as “truth.” It include corpus versioning, doc-level trust scores, and inline citations in AI feedback. For example, the system or method provided retrieves scenario- and rubric-specific passages from a versioned, access-controlled knowledge base(s) to constrain both (i) NPC dialogue and (ii) evaluator feedback, rejecting tokens inconsistent with the trusted corpus.

The systems and methods provided include runtime safety and session-stop logic plus prompt and response guardrails. Aspects of the system (e.g., machine readable instructions or algorithms) can be included to provide some safeguards or boundaries for user inputs in interacting with a non-player character. Such instructions can follow the following, generic, set of instructions; (a) detect disallowed or unsafe trainee (i.e., user) behavior/phrasing; (b) NPC utters a boundary phrase; (c) immediate scenario termination with feedback; (d) log the safety incident. Options of the system/method include adding a further guardrail layer (e.g., “Model Armor”), which includes filtering prompts/responses at runtime and enforcement policies per scenario/organization. For example, upon detection of an input that runs afoul of safety criteria (e.g., an inappropriate or otherwise improper input), the controller transitions to a terminal state that halts the simulation and triggers rubric-grounded corrective feedback; prompts and responses are filtered in real time by a safety model.

The system can include multi-tenancy, role-based access, including single sign on and/or token handoffs. Such additions allow control and/or isolation based upon the designation of a user, administrator, trainer, trainee, etc. The additional also allows for environmental separation (separation between developers, testers, production, and scale). The single sign on (SSO) can utilize existing systems (e.g., Google, Clever, Azure B2C, or other known system). Token based handoffs can be used for LMS/add-on launches. Advantages of such a system provides a multi-tenant training platform that provisions organization-scoped roles and initiates single-sign-on and token-based cross-application launches while preserving tenant data isolation.

The system can include an analytics and administrator feedback layer, which can include message-level ratings, dashboards, and/or pipelines. The analytics data model that has been described as part of the system includes events, steps, ratings per message, overall scores, and/or quality components. Administrator review tools can be included to provide additional feedback to the user/trainee. This can include persisting per-utterance ratings and evaluator outputs to an analytics store and rendering organization-scoped dashboards, with admin annotations feeding a continuous improvement loop. The feedback can take many forms, including, but not limited to, ratings dashboards, administrator feedback, or other feedback. The information used in the feedback can take into account many factors of the interaction between the user and the AI characters. For example, word count, tone, long-term records (for continued training of a user), sentiment, and any other aspect of the communication between the user and the AI character can be evaluated to provide feedback to the user. The more information utilized, the more specific the feedback can be in what went well, what went wrong, as well as areas that need to be worked on, based upon research that has been input into the models of the system.

The system can include benchmarking to rubrics, such as by way of an AI evaluator avatar and/or accuracy targets. The evaluator can present as an avatar with selected feedback styles (e.g., direct/data-driven/empathetic), and you track rubric accuracy thresholds by scenario type. Such feedback can be positive, such as by way of milestones achieved which prompt the AI evaluator avatar to appear with praise.

The system can include parameter-flexible scenarios configuration, an assignment communication engine, and learning-linkbacks. As noted, the avatar can be parameterized with templates (e.g., mood, relationship, difficulty, traits, etc.) that is shareable via link or assignment objects. After a session, a user can be directed to embedded learning-content (or by way of links) to specific curriculum pages/videos. These specific templates will trigger responses that, if not followed, can be provided via the system for additional training. This includes generating shareable, parameterized scenario instances and, post-evaluation, emitting prescriptive links to selected learning objects mapped to rubric deficits.

The system can include audio/video “Quality Components” measurements, which will be beyond text. The advantage of such components includes computing non-verbal quality components from audio/video signals and incorporating them into real-time scenario state transitions and evaluator scoring.

The system can include accommodations, such as complying with ADA 508, to provide greater accessibility. In addition, the system can be equipped to include multilingual inputs and/or outputs with localized accents/voices (such as selected based upon a user’s known location) and can also include offline caching and/or retry logic.

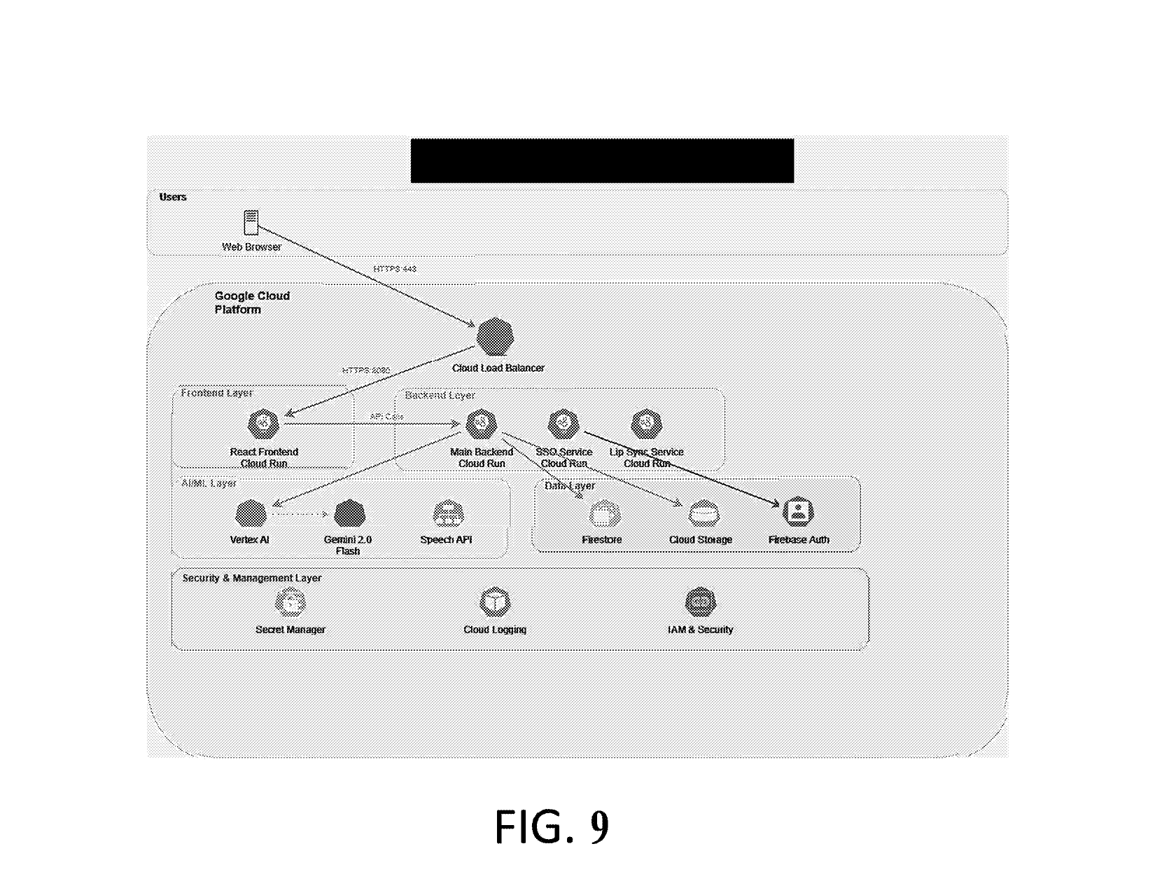

As shown in FIG. 9, the operational architecture for at least some embodiments is provided. This includes, for example, Vertex AI Multimodal Live, WebRTC, Cloud Run services, API gateway, Cloud IAM, logging/monitoring, and Model Armor. The result is a system that includes a streaming multimodal training service with bidirectional WebSocket transport to a hosted multimodal LLM, protected by runtime guardrails and cloud IAM.”

The systems and applications provided can simulate a wide range of scenarios, making it invaluable for training in behavioral science, research, healthcare, emergency response, education, etc. Its virtual environment and technology enable the creation of dynamic situations that may be impractical or impossible to replicate in real-life settings.

The parameters can be flexible to account for the different scenarios. While some training of the system is based in high stress situations, all different scenarios are envisioned. This can include, but is not limited to bedside manner training, prison/prisoner interaction training, hostage negotiation training, military training, and any other difficult training scenarios. The virtual training allows for such high-risk, difficult scenarios to be trained using trained models in a safe environment. It is noted that many of these types of scenarios are not common, so it is difficult to get on the job training. Having the system set up to present many difficult scenarios provides flexibility to train users in a safe environment, setting them up for best possible success should a real-world event occur.

The fusion of AI, Extended Reality, detailed character traits, and instructional methods enables an advanced and immersive digital training experience. These combinations establish a new benchmark in gamified training, providing an experience where each AI character is not merely a simulated figure but a fully realized entity in a world where a range of outcomes reflects the complexity and unpredictability of real life.

Therefore, systems and method to train human users in a game-like environment with AI-driven characters has been shown and/or described. It should be appreciated that variations and/or changes to any of the components or embodiments that are obvious to those skilled in the art are to be considered a part of the present disclosure. In addition, any of the aspects of any of the embodiments disclosed could be combined in ways not explicitly shown and/or described to provide yet additional embodiments that are part of the disclosure. The disclosure is not to be limited to the embodiments disclosed herein.

1. A system, comprising:
an AI character comprising at least one psychological traits selective from one or more of a plurality of a psychological diagnoses, background, trauma, neurotypical characteristic, and/or divergent characteristic;
at least one user input to communicate with the AI character; and
a training model associated with the AI character and the at least one user input, the training model trained to identify classifiers associated with the at least one user input, wherein the classifiers comprise an acceptable input from the at least one user input to satisfy the AI character.

2. The system of claim 1, wherein the at least one user input comprises:
a. a keyboard;
b. a microphone; and/or
c. computer vision comprising a camera, sensor, and/or Lidar.

3. The system of claim 2, further comprising a text-to-speech model.

4. The system of claim 2, further comprising a speech-to-text model.

5. The system of claim 1, wherein the AI character comprises a large language model, the large language model configured to prompt the AI character to respond to one or more user inputs based on the at least one psychological traits of the AI character.

6. The system of claim 1, further comprising an output generator to output a summary of an interaction between a user and the AI character.

7. The system of claim 1, wherein the output generator outputs a transcript of the at least one user inputs and one or more responses from the AI character.

8. The system of claim 1, further comprising a processor in communication with the AI character and the user input and storing the training model.

9. The system of claim 1, further comprising an emotional recognition model that is capable of recognizing an emotion of a user and to communicate the emotion to the AI character.

10. A virtual training simulation system, comprising:
at least one processor, the at least one processor configured to:
present an AI character to a user, the AI character displaying at least one psychological traits selective from one or more of a plurality of a psychological diagnoses, background, trauma, neurotypical characteristic, and/or divergent characteristic;
receive a user input from a user via at least one user input, the input in response to a prompt from the AI character and based on a programmed scenario;
compare the received user input via a training model, wherein the training model is trained with inputs that includes a plurality of reactions based upon a plurality of inputs to identify reactions to the plurality of inputs; and
output a response from the AI character that has been selected by the training model based upon the received user input.

11. The virtual training simulation system of claim 10, wherein the at least one user input comprises:
a. a keyboard;
b. a microphone; and/or
c. computer vision comprising a camera, sensor, and/or Lidar.

12. The virtual training simulation system of claim 11, further comprising receiving emotional recognition data from the user via the computer vision and using the emotional recognition data in the training model to determine the output response from the AI character.

13. The virtual training simulation system of claim 10, wherein the at least one processor further configured to convert a text response from the AI character to synthetic speech.

14. The virtual training simulation system of claim 10, wherein the at least one processor further configured to convert a speech file from the at least one user input to a text file for the AI character.

15. The virtual training simulation system of claim 10, wherein the at least one processor further configured to output a transcript of user inputs and AI character responses for evaluation.

16. The virtual training simulation system of claim 10, wherein the AI character is a machine-learned model that has been trained using traits and characteristics of real people in order to provide responses similar to real people.

17. A virtual training method, comprising:
receiving at least one action in the form of a movement and/or a message from an AI character in a virtual environment;
based upon the received action, inputting a response from a human user via one or more user inputs;
comparing the inputted response via a training model that has been trained to review training steps for addressing behavior events and instructing the AI character to react based upon the compared response; and
evaluating the inputted response to train the human user to handle different actions.

18. The method of claim 17, wherein the inputted response comprises a keyboard input, a spoken input, and/or an emotional recognition input.

19. The method of claim 17, wherein the AI character comprises a large language model to respond, in real time, to the inputted response.

20. The method of claim 17, wherein the step of evaluating the inputting response comprises the creation of a transcript between the user and the AI character.
